(19) United States
(12) Patent Application Publication
(10) Pub. No.: US 2026/0035159 A1
(43) Pub. Date: Feb. 5, 2026

(54) MULTIPLE BAG FREEZING CONTAINER

(71) Applicant: ENTEGRIS, INC., Billerica, MA (US)

(72) Inventors: Troy Galanis, North Billerica, MA (US); Robert M. Shydo, JR., Hampstead, NH (US); Jacob Peabody, Roxbury, MA (US); Jessie M. Geannaris, Londonberry, NH (US)

(21) Appl. No.: 19/286,106

(22) Filed: Jul. 30, 2025

Related U.S. Application Data
(60) Provisional application No. 63/677,394, filed on Jul. 30, 2024.

(51) Int. Cl. B65D 81/18; B65D 71/50

(52) U.S. Cl. CPC B65D 81/18; B65D 71/50

(57) ABSTRACT

Containers for a plurality of bags, such as bioprocess bags, include a first container segment configured to directly contact a first plurality of bags arranged in a first layer and a second container segment configured to be attached to the first container segment. The second container segment is configured to contact a second plurality of bags arranged in a second layer. The container includes a compression layer configured to be positioned between the first plurality of bags and the second plurality of bags such that the first plurality of bags are pressed against the first container segment and the second plurality of bags are pressed against the second container segment when the first container segment is attached to the second container segment.

### FIELD

This disclosure is directed to containers for freezing or thawing of a plurality of bags such as bioprocess bags.

### BACKGROUND

Certain processes in industries such as the pharmaceutical industry are performed in small bags. Using individual containers for each small bag would be expensive and would require extensive handling and manipulation to place the bags into the respective containers.

### SUMMARY

This disclosure is directed to containers for freezing or thawing of a plurality of bags such as bioprocess bags.

By allowing multiple bags to be placed within a single larger container, handling can be simplified and container costs can be reduced while allowing a plurality of small bags to be used for bioprocesses such as drug manufacture. Further, the use of current container sizes ensures compatibility with existing freezing and thawing infrastructure. Additionally, by pressing bags against thermally conductive surfaces, the freezing or thawing speeds can be improved and also made more consistent. The compression layer can also provide a path for thermal conductivity to an interior of the container, to further improve the speed and consistency of freezing or thawing operations on bags contained within the container.

In an embodiment, an apparatus includes a container. The container includes a first container segment configured to directly contact a first plurality of bags arranged in a first layer, a second container segment configured to be attached to the first container segment, the second container segment configured to contact a second plurality of bags arranged in a second layer, and a compression layer. The compression layer is configured to be positioned between the first plurality of bags and the second plurality of bags such that the first plurality of bags are pressed against the first container segment and the second plurality of bags are pressed against the second container segment when the first container segment is attached to the second container segment.

In an embodiment, the apparatus further includes a plurality of dividers, each divider of the plurality of dividers disposed between at least two of the first plurality of bags.

In an embodiment, the apparatus further includes a plurality of dividers, each divider of the plurality of dividers disposed between at least two of the second plurality of bags.

In an embodiment, the first container segment and the second container segment are each formed of metal.

In an embodiment, the compression layer includes a polymer.

In an embodiment, the compression layer includes a metal.

In an embodiment, the compression layer is formed of a padding material.

In an embodiment, the compression layer has a thermal conductivity in a range from 15 to 215 W/(mK).

In an embodiment, the compression layer is configured to directly contact bags of the first plurality of bags.

In an embodiment, the compression layer is configured to directly contact bags of a third plurality of bags, wherein the bags of the third plurality of bags each directly contact at least one bag of the first plurality of bags.

In an embodiment, the compression layer is configured to directly contact bags of the second plurality of bags.

In an embodiment, the compression layer is configured to directly contact bags of a third plurality of bags, wherein the bags of the third plurality of bags each directly contact at least one bag of the second plurality of bags.

In an embodiment, a method includes arranging a first plurality of bags in a first layer directly contacting a first container segment of a container, placing a compression layer within the first container segment, arranging a second plurality of bags in a second layer, and attaching a second container segment to the first container segment to close the container. When the second container segment is attached to the first container segment, the second plurality of bags directly contact the second container segment, the first plurality of bags is compressed against the first container segment, and the second plurality of bags is compressed against the second container segment.

In an embodiment, the compression layer directly contacts the first plurality of bags.

In an embodiment, the compression layer directly contacts the second plurality of bags.

In an embodiment, the method further includes placing a third plurality of bags such that each bag of the third plurality of bags is in direct contact with at least one bag of the first plurality of bags, wherein the compression layer directly contacts the third plurality of bags.

In an embodiment, the method further includes placing a third plurality of bags such that each bag of the third plurality of bags is in direct contact with at least one bag of the second plurality of bags, wherein the compression layer directly contacts the third plurality of bags.

In an embodiment, the first container segment and the second container segment are each formed of metal.

In an embodiment, the method further includes, after attaching the second container segment to the first container segment, freezing contents of bags within the container.

In an embodiment, the method further includes, after attaching the second container segment to the first container segment, thawing contents of bags within the container.

### DRAWINGS

FIG. 1 shows an exploded view of a container according to an embodiment.

FIG. 2 shows an exploded view of a container according to an embodiment.

FIG. 3 shows an exploded view of a container according to an embodiment.

FIG. 4 shows a compression layer according to an embodiment.

FIG. 5 shows a compression layer according to an embodiment.

FIG. 6 shows a flowchart of a method according to an embodiment.

### DETAILED DESCRIPTION

This disclosure is directed to containers for freezing or thawing of a plurality of bags such as bioprocess bags.

As used herein, “directly contact” means to be in physical contact with one another, without any materials between the items stated to “directly contact” one another.

As used herein, “attached” means secured to one another, for example by mechanical features, fasteners, or the like. For example, container segments are considered “attached” to one another when the container is closed and the closure is secured by way of the suitable features, fasteners, or the like.

As used herein, “pressed” means to apply a compressive force, directly or indirectly, by interference between the item pressing and one of the items being pressed or one or more additional bodies in contact with said item being pressed.

As used herein, “compression layer” is a structure configured to be provided between layers of bags and/or dividers within a container, so as to contact bags of at least one layer of bags.

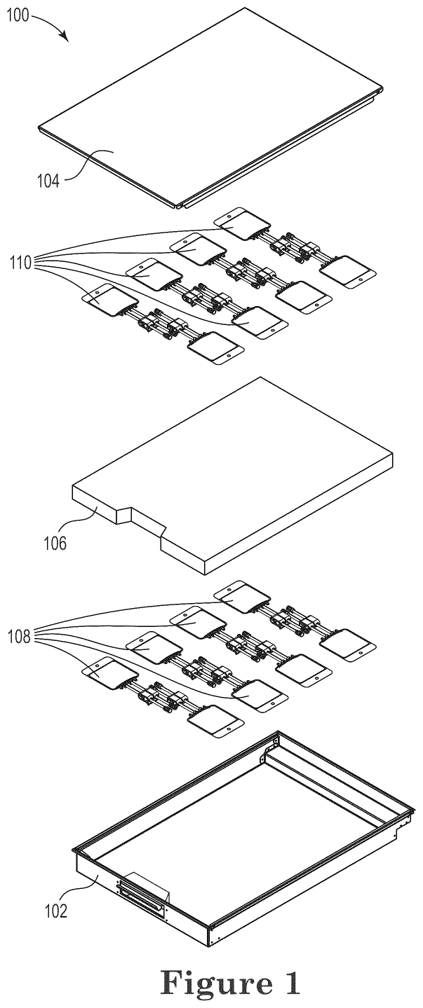

FIG. 1 shows an exploded view of a container according to an embodiment. Container 100 includes first segment 102 and second segment 104. Container 100 further includes compression layer 106. A first plurality of bags 108 and a second plurality of bags 110 can each be stored within the container 100.

Container 100 is a container configured to contain a plurality of bags such as bioprocess bags. Container 100 can be used to contain the bags during operations such as freezing and/or thawing of the bags. Container 100 can be shaped and/or sized to be used with a blast freezer, a plate freezer, a refrigerator, a thawing apparatus, a warmer, or the like. In an embodiment, the container shell 100 is formed of a thermally conductive material, for example a metal or alloy thereof, a thermally conductive polymer, or the like. Container 100 can include a first segment 102 and a second segment 104 that are configured to be combined to define an internal space capable of accommodating the first and second pluralities of bags 108, 110 in at least two layers. Each of first segment 102 and second segment 104 can be configured such that an internal surface of the respective segment 102, 104 is the conductive material which the segment 102, 104 is formed of. In an embodiment, first segment 102 and second segment 104 do not include any inserts, padding, foams, or other material on a bag contacting surface thereof. First segment 102 is configured to directly contact a first plurality of bags 108, which can be distributed in a layer on an internal surface of the first segment 102. Second segment 104 is configured to directly contact a second plurality of bags 110 when attached to the first segment 102 to enclose the container 100. The second plurality of bags can be, for example, distributed in a layer on compression layer 106 or on an intermediary, for example another plurality of bags or the like. First segment 102 can be a lower portion of the container 100 and second segment 104 can be a cover, lid, or upper portion of container 100.

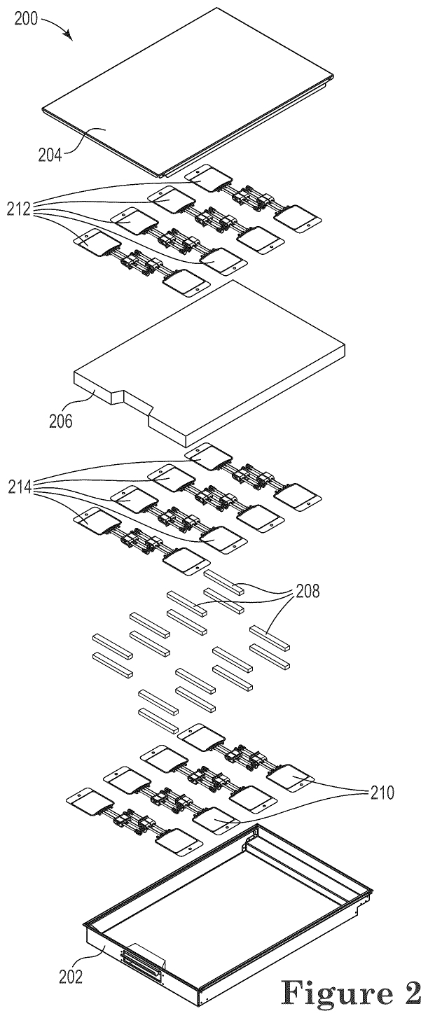

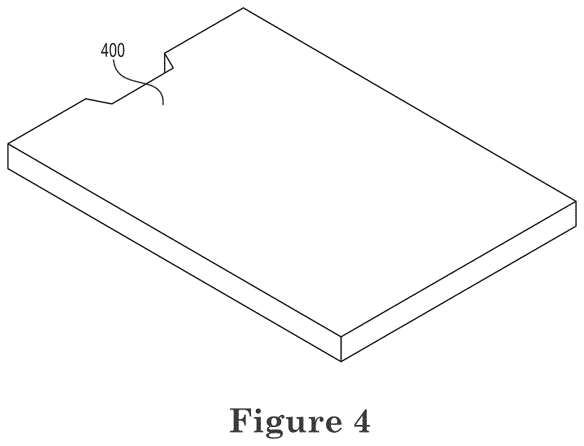

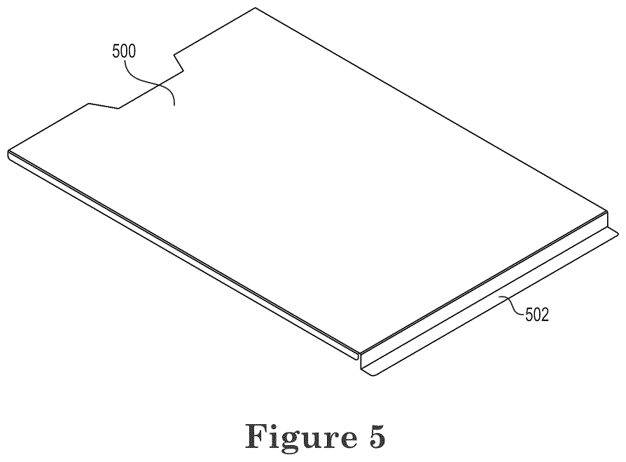

Compression layer 106 is a layer configured to be positioned between first plurality of bags 108 and second plurality of bags 110 within the container 100. The compression layer 106 is configured to press the first plurality of bags 108 against the first segment 102 and the second plurality of bags 110 against the second segment 104. In an embodiment, the compression layer 106 is configured to directly press the bags of each of the first plurality of bags 108 and the second plurality of bags 110. In an embodiment, the compression layer 106 is configured to indirectly press at least one of the first plurality of bags 108 and the second plurality of bags 110, for example by pressing against another body in contact with the first plurality of bags 108 or the second plurality of bags 110, such as a third plurality of bags, for example as shown in FIG. 2 and described below. Compression layer 106 is configured such that a compressive force on the bags is below a level that would present a risk of rupture of the bags. The compression layer 106 can be formed of any suitable material, for example a foam, a polymer, a metal, combinations thereof, and the like. The compression layer 106 can include a material having a thermal conductivity in a range from 15 to 215 W/(mK). The thermally conductive material can be a metal or a thermally conductive polymer. In an embodiment, the compression layer is formed of a non-thermally conductive polymer, such as polycarbonate or high-density polyethylene (HDPE). In an embodiment, the material used in compression layer 106 is capable of withstanding cold or cryogenic conditions, for example temperatures of −80° C. or lower. In an embodiment, the thermally conductive material contacts at least one of first segment 102 and second segment 104 at a thermally conductive portion thereof. In an embodiment, the compression layer 106 is composed of gamma-stable materials capable of being irradiated with gamma radiation without significant degradation of the structure or mechanical properties thereof. In an embodiment, compression layer 106 is a sheet of foam. In an embodiment, compression layer 106 is a metal and/or polymer shell. Non-limiting embodiments of compression layers 106 are shown in FIGS. 4 and 5 and described in further detail below.

Compression layer 106 include one or more features such as clips, flanges, guide projections, recesses, or the like configured to position, guide, or retain tubes extending from bags of the respective first and/or second plurality of bags 108, 110. The tubes can be retained so as to control a bending radius to reduce the risk of breakage, guide the tubes so as to avoid contact between tubes and fittings provided thereon with bags of the first and/or second third plurality of bags 108, 110.

First plurality of bags 108 are bags such as bioprocess bags arranged in a single layer. The first plurality of bags 108 can include any suitable number of bags based on the shape and size of the bags relative to the shape and size of first segment 102. The first plurality of bags 108 can be placed onto an internal surface of first segment 102.

Second plurality of bags 110 are bags such as bioprocess bags arranged in a single layer. The second plurality of bags 110 can include any suitable number of bags based on the shape and size of the bags relative to the shape and size of second segment 110 and/or any structure the second plurality of bags 110 rest upon, for example the compression layer 106 or one or more intermediaries positioned between second plurality of bags 110 and the compression layer 106. An example of such intermediaries is one or more additional layers of bags. The second plurality of bags 110 can be placed onto the compression layer 106 or the one or more intermediaries to provide an uppermost layer of bags positioned to contact second segment 104 when second segment 104 is attached for first segment 102.

FIG. 2 shows an exploded view of a container according to an embodiment. Container 200 includes first segment 202, second segment 204, compression layer 206, and divider 208. Container 200 is configured to accommodate first plurality of bags 210, second plurality of bags 212, and third plurality of bags 214.

Container 200 is a container configured to contain a plurality of bags such as bioprocess bags. Container 200 can be used to contain the bags during operations such as freezing and/or thawing of the bags. Container 200 can be shaped and/or sized to be used with a blast freezer, a plate freezer, a refrigerator, a thawing apparatus, a warmer, or the like. In an embodiment, the container shell 200 is formed of a thermally conductive material, for example a metal or alloy thereof, a thermally conductive polymer, or the like. Container 200 can include a first segment 202 and a second segment 204 that are configured to be combined to define an internal space capable of accommodating the first, second, and third plurality of bags 210, 212, 214 in at least three layers. Each of first segment 202 and second segment 204 can be configured such that an internal surface of the respective segment 202, 204 is the conductive material which the segment 202, 204 is formed of. In an embodiment, first segment 202 and second segment 204 do not include any inserts, padding, foams, or other material on a bag contacting surface thereof. First segment 202 is configured to directly contact a first plurality of bags 210, which can be distributed in a layer on an internal surface of the first segment 202. Second segment 204 is configured to directly contact a second plurality of bags 212 when attached to the first segment 202 to enclose the container 200. The second plurality of bags can be, for example, distributed in a layer on compression layer 206 or on an intermediary, for example another plurality of bags or the like. First segment 202 can be a lower portion of the container 200 and second segment 204 can be a cover, lid, or upper portion of container 200.

Compression layer 206 is a layer configured to be positioned between first plurality of bags 210 and second plurality of bags 212 within the container 200. The compression layer is configured to press the first plurality of bags 210 against the first segment 202 and the second plurality of bags 212 against the second segment 204. In the embodiment shown in FIG. 2, the compression layer 206 is configured to directly contact the bags of each of the third plurality of bags 214 and the second plurality of bags 212. In the embodiment shown in FIG. 2, the compression layer indirectly presses the first plurality of bags 210 into the first segment 202 indirectly, by way of contacting third plurality of bags 214. Compression layer 206 is configured such that a compressive force on the bags is below a level that would present a risk of rupture of the bags. The compression layer 206 can be formed of any suitable material, for example a foam, a polymer, a metal, combinations thereof, and the like. The compression layer 206 can include a material having a thermal conductivity in a range from 15 to 215 W/(mK). The thermally conductive material can be a metal or a thermally conductive polymer. In an embodiment, the compression layer 206 is formed of a non-thermally conductive polymer, such as polycarbonate or high-density polyethylene (HDPE). In an embodiment, the material used in compression layer 206 is capable of withstanding cold or cryogenic conditions, for example temperatures of −80° C. or lower. In an embodiment, the thermally conductive material contacts at least one of first segment 202 and second segment 204 at a thermally conductive portion thereof. In an embodiment, the compression layer 206 is composed of gamma-stable materials capable of being irradiated with gamma radiation without significant degradation of the structure or mechanical properties thereof. In an embodiment, compression layer 206 is a sheet of foam. In an embodiment, compression layer 206 is a metal and/or polymer shell. While one compression layer 206 is shown in FIG. 2, it is understood that additional compression layers can be provided between different pluralities of bags, for example including another compression layer between the first plurality of bags 210 and the third plurality of bags 214, in addition to the compression layer 206 shown in FIG. 2 as positioned between the third plurality of bags 214 and the second plurality of bags 212.

Dividers 208 can be positioned in first segment 202. The dividers 208 can be configured to separate bags of the first plurality of bags 210 and/or the third plurality of bags 214. In an embodiment, the dividers 208 can be configured to define a plurality of zones each configured to accommodate one of the first plurality of bags 210 and one of the third plurality of bags 214. The dividers 208 can be configured to position bags of the third plurality of bags 214 such that said bags directly contact one of more bags of the first plurality of bags 210. The dividers 208 can be configured to position the bags of the first plurality of bags 210 and/or the third plurality of bags 214 in any suitable relative positions such as a grid or array. Dividers 208 can be formed of any suitable material, such as foam, metal, polymer, or combinations thereof. In an embodiment, the dividers 208 can be formed of a metal or a thermally conductive polymer. In an embodiment, the dividers 208 can be formed of a non-thermally conductive polymer, such as polycarbonate or high-density polyethylene (HDPE). In an embodiment, the material used in dividers 208 is capable of withstanding cold or cryogenic conditions, for example temperatures of −80° C. or lower. In an embodiment, the dividers 208 can be composed of gamma-stable materials capable of being irradiated with gamma radiation without significant degradation of the structure or mechanical properties thereof. In an embodiment, dividers 208 can contact the compression layer 206.

Compression layer 206 and/or at least some of dividers 208 can include one or more features such as clips, flanges, guide projections, recesses, or the like configured to position, guide, or retain tubes extending from bags of the respective first, second, and/or third plurality of bags 210, 212, 214. The tubes can be retained so as to control a bending radius to reduce the risk of breakage, guide the tubes so as to avoid contact between tubes and fittings provided thereon with bags of the first, second, and/or third plurality of bags 210, 212, 214.

First plurality of bags 210 are bags such as bioprocess bags arranged in a single layer. The first plurality of bags 210 can include any suitable number of bags based on the shape and size of the bags relative to the shape and size of first segment 202. The first plurality of bags 210 can be placed onto an internal surface of first segment 202. In the embodiment shown in FIG. 2, the dividers 208 define positions for the bags of the first plurality of bags 210.

Second plurality of bags 212 are bags such as bioprocess bags arranged in a single layer. The second plurality of bags 212 can include any suitable number of bags based on the shape and size of the bags relative to the shape and size of second segment 212 and/or any structure the second plurality of bags 212 rest upon, for example the compression layer 206 or one or more intermediaries positioned between second plurality of bags 212 and the compression layer 206. An example of such intermediaries is one or more additional layers of bags. The second plurality of bags 212 can be placed onto the compression layer 206 or the one or more intermediaries to provide an uppermost layer of bags positioned to contact second segment 204 when second segment 204 is attached for first segment 202.

Third plurality of bags 214 is a plurality of bags arranged in a layer and positioned between the first plurality of bags 210 and the compression layer 206. Third plurality of bags 214 can be positioned to each directly contact a corresponding one or more of the first plurality of bags 210. Bags of the third plurality of bags 214 can be positioned to be in a heat exchange relationship with corresponding one or more of the first plurality of bags 210, such that the first plurality of bags 210 can conduct heat to or away from the third plurality of bags 214 such that heating or cooling of the first segment 202 can add or remove heat from the third plurality of bags 214. In an embodiment, the number and size of the bags of the third plurality of bags each equal the number and size of the bags of the first plurality of bags 210. In the embodiment shown in FIG. 2, the dividers 208 define positions for the bags of the third plurality of bags 214. The dividers 208 can, for example, define positions for the third plurality of bags 214 such that each of the third plurality of bags is associated with one or more corresponding bags of the first plurality of bags 210.

While third plurality of bags 214 are shown as being between the first plurality of bags 210 and the compression layer 206, it is understood that the third plurality of bags 214 could instead be positioned between the compression layer 206 and the second plurality of bags 212. In an embodiment, third plurality of bags 214 can be replaced by a thermally conductive intermediary. In an embodiment, in addition to the third plurality of bags 214, additional layers of bags such as a fourth plurality of bags (not shown) can be provided either between the first plurality of bags 210 and the second plurality of bags 214, between the compression layer 206 and second plurality of bags 212, or included between other layers of bags and/or intermediaries contained within the container 200.

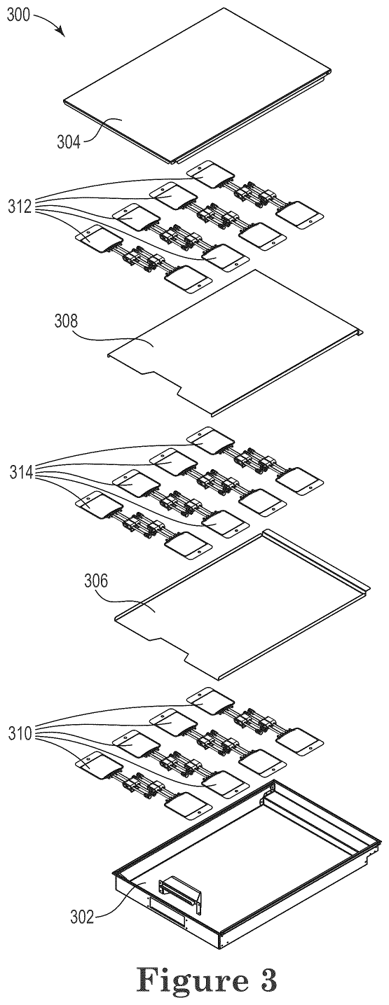

FIG. 3 shows a container according to an embodiment. Container 300 includes a first segment 302, a second segment 304, a first compression layer 306, and a second compression layer 308. Container 300 is configured to accommodate a first plurality of bags 310, a second plurality of bags 312, and a third plurality of bags 314.

Container 300 is a container configured to contain a plurality of bags such as bioprocess bags. Container 300 can be used to contain the bags during operations such as freezing and/or thawing of the bags. Container 300 can be shaped and/or sized to be used with a blast freezer, a plate freezer, a refrigerator, a thawing apparatus, a warmer, or the like. In an embodiment, the container shell 300 is formed of a thermally conductive material, for example a metal or alloy thereof, a thermally conductive polymer, or the like. Container 300 can include a first segment 302 and a second segment 304 that are configured to be combined to define an internal space capable of accommodating the first, second, and third pluralities of bags 310, 312, 314 in at least three layers. Each of first segment 302 and second segment 304 can be configured such that an internal surface of the respective segment 302, 304 is the conductive material which the segment 302, 304 is formed of. In an embodiment, first segment 302 and second segment 304 do not include any inserts, padding, foams, or other material on a bag contacting surface thereof. First segment 302 is configured to directly contact a first plurality of bags 310, which can be distributed in a layer on an internal surface of the first segment 302. Second segment 304 is configured to directly contact a second plurality of bags 312 when attached to the first segment 302 to enclose the container 300. The second plurality of bags can be, for example, distributed in a layer on compression layer 306 or on an intermediary, for example another plurality of bags or the like. First segment 302 can be a lower portion of the container 300 and second segment 304 can be a cover, lid, or upper portion of container 300.

First compression layer 306 is a layer configured to be positioned between first plurality of bags 310 and third plurality of bags 314 within the container 300. The first compression layer 306 is configured to press the first plurality of bags 310 against the first segment 302. In an embodiment, the first compression layer 306 is configured to directly press each of the bags of the first plurality of bags 310. In an embodiment, the first compression layer 306 is configured to indirectly press the first plurality of bags 310, for example by pressing against another body in contact with the first plurality of bags 310. First compression layer 306 and second compression layer 308 is configured such that a compressive force on the bags within container 300 are below a level that would present a risk of rupture of the bags. The first compression layer 306 can be formed of any suitable material, for example a polymer, a metal, combinations thereof, and the like. The first compression layer 306 can include a material having a thermal conductivity in a range from 15 to 215 W/(mK). The thermally conductive material can be a metal or a thermally conductive polymer. In an embodiment, the compression layer is formed of a non-thermally conductive polymer, such as polycarbonate or high-density polyethylene (HDPE). In an embodiment, the material used in first compression layer 306 is capable of withstanding cold or cryogenic conditions, for example temperatures of −80° C. or lower. In an embodiment, the thermally conductive material of first compression layer 306 contacts at least one of first segment 302 and second segment 304 at a thermally conductive portion thereof. In an embodiment, the first compression layer 306 is composed of gamma-stable materials capable of being irradiated with gamma radiation without significant degradation of the structure or mechanical properties thereof. In an embodiment, first compression layer 306 is a metal and/or polymer shell. A non-limiting embodiment of first compression layer 306 is shown in FIG. 5 and described in further detail below.

Second compression layer 308 is a layer configured to be positioned between third plurality of bags 314 and second plurality of bags 312 within the container 300. The second compression layer 308 is configured to press the second plurality of bags 312 against the second segment 304. In an embodiment, the second compression layer 308 is configured to directly press each of the bags of the second plurality of bags 312. In an embodiment, the second compression layer 308 is configured to indirectly press the second plurality of bags 312, for example by pressing against another body in contact with the second plurality of bags 312. First compression layer 306 and second compression layer 308 are configured such that a compressive force on the bags within container 300 are below a level that would present a risk of rupture of the bags. The second compression layer 308 can be formed of any suitable material, for example a polymer, a metal, combinations thereof, and the like. The second compression layer 308 can include a material having a thermal conductivity in a range from 15 to 215 W/(mK). The thermally conductive material can be a metal or a thermally conductive polymer. In an embodiment, the compression layer is formed of a non-thermally conductive polymer, such as polycarbonate or high-density polyethylene (HDPE). In an embodiment, the material used in second compression layer 308 is capable of withstanding cold or cryogenic conditions, for example temperatures of −80° C. or lower. In an embodiment, the thermally conductive material of first compression layer 306 contacts at least one of first segment 302 and second segment 304 at a thermally conductive portion thereof. In an embodiment, the second compression layer 308 is composed of gamma-stable materials capable of being irradiated with gamma radiation without significant degradation of the structure or mechanical properties thereof. In an embodiment, second compression layer 308 is a metal and/or polymer shell. A non-limiting embodiment of second compression layer 308 is shown in FIG. 5 and described in further detail below. In an embodiment, first compression layer 306 and second compression layer 308 can be identical to one another. In an embodiment, first compression layer 306 and second compression layer 308 can have different shapes from one another. In an embodiment, the first compression layer 306 and second compression layer 308 are configured to cooperate with one another, for example contacting one another at one or more contact surfaces thereof, having one or more interfacing features, or the like.

First compression layer 306 and/or second compression layer 308 can include one or more features such as clips, flanges, guide projections, recesses, or the like configured to position, guide, or retain tubes extending from bags of the respective first, second, and/or third plurality of bags 310, 312, 314. The tubes can be retained so as to control a bending radius to reduce the risk of breakage, guide the tubes so as to avoid contact between tubes and fittings provided thereon with bags of the first, second, and/or third plurality of bags 310, 312, 314.

First plurality of bags 310 are bags such as bioprocess bags arranged in a single layer. The first plurality of bags 310 can include any suitable number of bags based on the shape and size of the bags relative to the shape and size of first segment 302. The first plurality of bags 310 can be placed onto an internal surface of first segment 302. In an embodiment, the first plurality of bags 310 can have dividers, such as the dividers 208 described above and shown in FIG. 2 disposed between individual bags of the first plurality of bags 310. In an embodiment, first plurality of bags 310 are in contact with the first compression layer 306. In an embodiment, one or more intermediaries, such as a layer including a plurality of bags can be positioned between the first plurality of bags and the first compression layer 306.

Second plurality of bags 312 are bags such as bioprocess bags arranged in a single layer. The second plurality of bags 312 can include any suitable number of bags based on the shape and size of the bags relative to the shape and size of second segment 312 and/or any structure the second plurality of bags 312 rest upon, for example the second compression layer 308 or one or more intermediaries positioned between second plurality of bags 312 and the second compression layer 308. An example of such intermediaries is one or more additional layers of bags. The second plurality of bags 312 can be placed onto the second compression layer 308 or the one or more intermediaries to provide an uppermost layer of bags positioned to contact second segment 304 when second segment 304 is attached for first segment 302.

Third plurality of bags 314 are bags such as bioprocess bags arranged in a single layer. The third plurality of bags 314 can be positioned between the first compression layer 306 and the second compression layer 308. The third plurality of bags 314 can be placed on the first compression layer 306. The third plurality of bags can be in direct contact with the first compression layer 306. In an embodiment, the third plurality of bags 314 can be in direct contact with both the first compression layer 306 and the second compression layer 308. In an embodiment, one or more intermediaries, such as an additional layer of bags can be placed between the third plurality of bags 314 and the second compression layer 308.

FIG. 4 shows a compression layer according to an embodiment. Compression layer 400 is a sheet of foam configured to fit within a corresponding container, such as container 100 or container 200 as described above and shown in FIGS. 1 and 2. Compression layer 400 can have a thickness and/or material selected to apply suitable compressive force to bags within the container so as to press the bags against respective internal surfaces of segments of the container, while remaining below a threshold compressive force that could risk the rupturing of bags. The selection of the thickness and/or material for compression layer 400 can be based on the size, shape, target extent of filling, materials, bonding methods, or any other suitable characteristics of the bags, and the shape and size of the internal space of the container. In an embodiment, compression layer 400 can include recesses configured to correspond to the positions of bags. In an embodiment, the compression layer 400 is composed of a gamma-stable foam capable of being irradiated with gamma radiation without significant degradation of the structure or mechanical properties thereof.

FIG. 5 shows a compression layer according to an embodiment. Compression layer 500 is a formed sheet of a polymer or a metal configured to fit within a corresponding container, such as container 100, container 200, or container 300 as described above and shown in FIGS. 1-3. Compression layer 500 can have a thickness or range of thicknesses across the compression insert 500 selected to apply suitable compressive force to bags within the container so as to press the bags against respective internal surfaces of segments of the container, while remaining below a threshold compressive force that could risk the rupturing of bags. The selection of the thickness or range of thicknesses for compression layer 500 can be based on the size, shape, target extent of filling, materials, bonding methods, or any other suitable characteristics of the bags, and the shape and size of the internal space of the container. In an embodiment, compression layer 500 can include recesses configured to correspond to the positions of bags. In an embodiment, the compression layer 500 is formed of a metal. In an embodiment, the compression layer 500 is formed of a thermally conductive polymer. In an embodiment, the compression layer 500 can be formed of a non-thermally conductive polymer, such as polycarbonate or high-density polyethylene (HDPE). In an embodiment, the material used in compression layer 500 is capable of withstanding cold or cryogenic conditions, for example temperatures of −80° C. or lower. In an embodiment, the compression layer 500 is composed of gamma-stable materials capable of being irradiated with gamma radiation without significant degradation of the structure or mechanical properties thereof. In an embodiment, compression layer 500 includes one or more flanges 502 configured to contact a segment of the container used with the compression layer 500, so as to provide a surface for heat transfer with said segment of the container. In an embodiment, such as the container 300 described above and shown in FIG. 3, the compression layer 500 can be shaped and/or sized to cooperate with a second compression layer so as to place bags into a thermal conduction relationship with an exterior of the container.

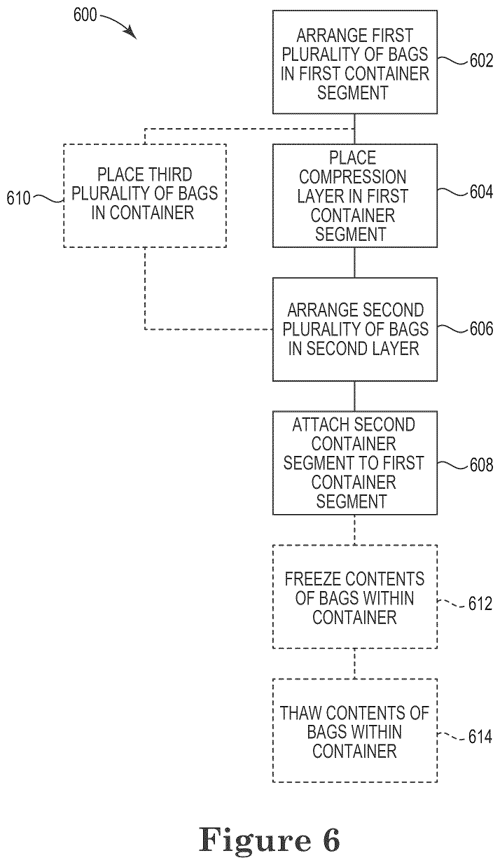

FIG. 6 shows a flowchart of a method according to an embodiment. Method 600 includes arranging a first plurality of bags in a first layer directly contacting a first container segment of a container 602, placing a compression layer within the first container segment 604, arranging a second plurality of bags in a second layer 606, and attaching a second container segment to the first container segment to close the container 608. Method 600 can optionally further include placing a third plurality of bags 610. Method 600 can optionally further include freezing contents of bags within the container 612. Method 600 can optionally further include thawing contents of bags within the container 614.

A first plurality of bags are arranged in a first layer directly contacting a first container segment of a container at 602. The first container segment is a portion of a container, combinable with a second container segment to define an internal space configured to accommodate at least the first plurality of bags, the second plurality of bags and the compression layer. The first plurality of bags can be any suitable bags, for example bioprocess bags. The first plurality of bags directly contact a thermally conductive material on an inner surface of the first container segment, such that the first plurality of bags can exchange heat with the exterior of the first container segment by way of conduction. In an embodiment, the arrangement of the first plurality of bags can be placing the bags within compartments defined by dividers, such as the dividers 208 described above and shown in FIG. 2.

A compression layer is placed within the first container segment at 604. The compression layer can be any suitable compression layers as described herein, with non-limiting examples being the compression layers 106, 206, 306, 308, 400, and 500 as described above and respectively shown in FIGS. 1-5. In an embodiment, the compression layer is placed directly on the first plurality of bags. In an embodiment, the compression layer is placed on dividers provided in the first container segment. In an embodiment, the compression layer is placed on an intermediary positioned between the compression layer and the first plurality of bags, such as one or more additional layers of bags and/or additional compression layers.

A second plurality of bags is arranged in a second layer at 606. The second plurality of bags can be arranged on the compression layer placed at 604 or an intermediary such as a third plurality of bags placed at optional 610, another plurality of bags, an additional compression layer, or the like. The second plurality of bags can be, for example, bioprocess bags. The second plurality of bags can be arranged to provide an uppermost layer of the contents of the container, such that the second plurality of bags directly contact the second container segment when the second container segment is attached to the first container segment.

A second container segment is attached to the first container segment to close the container at 608. The second container segment can be attached to the first container segment by any suitable connection, such as engagement features, one or more fasteners, combinations thereof, and the like. When the second container segment is attached to the first container segment at 608, the second container segment and the second plurality of bags can be in direct contact. In an embodiment, when the second container segment is attached to the first container segment at 608, the first plurality of bags can be pressed against the first container segment and the second container segment can be pressed against the second container segment.

Method 600 can optionally further include placing a third plurality of bags 610. The third plurality of bags can optionally be placed at 610 before the placement of the compression layer at 604 or after the placement of the compression layer at 604 but before the second plurality of bags are arranged in the second layer at 606. The third plurality of bags placed at 610 can be positioned to directly contact one of the first plurality of bags or the second plurality of bags and the compression layer. The third plurality of bags placed at 610 can be arranged in a single layer. In an embodiment, the third plurality of bags placed at 610 can be positioned so that each of the third plurality of bags directly contact one or more of the bags of the first plurality of bags or the second plurality of bags. In an embodiment, method 600 can further optionally include placing additional pluralities of bags in additional layers, positioned between the compression layer and the first plurality of bags or the second plurality of bags.

Method 600 can optionally further include freezing contents of bags within the container 612. After the container is closed at 608, the closed container can be placed within a suitable freezer, such as a plate freezer, a cold wall freezer, a blast freezer, or the like. In an embodiment, when the freezer is a plate freezer, the first container segment can directly contact a cooling plate of the plate freezer. The freezer can be operated to freeze the contents of the multiple bags contained within the container. The bags contacting the first and second container segments can exchange heat with the freezer by conduction, providing consistent and rapid freezing of the contents of those bags. Additional bags, such as the third plurality of bags optionally placed at 610, can also contact the first or second plurality of bags to directly exchange heat by conduction through such contact during the freezing at 612.

Method 600 can optionally further include thawing contents of bags within the container 614. The thawing at 614 can be performed at any suitable time when the contents of the bags within the container are frozen, for example after the container has been closed at 608 if the bags were added when frozen, following the optional freezing at 612, or the like. The thawing at 614 can be performed by placing the container at room temperature or in a dedicated thawing device such as a plate warmer, a convection thawing device, or the like. The bags contacting the first and second container segments can absorb heat from the thawing device and/or the ambient environment by conduction, providing consistent and rapid thawing of the contents of those bags. Additional bags, such as the third plurality of bags optionally placed at 610, can also contact the first or second plurality of bags to directly exchange heat by conduction through such contact during the thawing at 612.

### Aspects

It is understood that any of aspects 1-12 can be combined with any of aspects 13-20.

Aspect 1. An apparatus comprising a container, the container including:
a first container segment configured to directly contact a first plurality of bags arranged in a first layer;
a second container segment configured to be attached to the first container segment, the second container segment configured to contact a second plurality of bags arranged in a second layer;
a compression layer, the compression layer configured to be positioned between the first plurality of bags and the second plurality of bags such that the first plurality of bags are pressed against the first container segment and the second plurality of bags are pressed against the second container segment when the first container segment is attached to the second container segment.

Aspect 2. The apparatus according to aspect 1, further comprising a plurality of dividers, each divider of the plurality of dividers disposed between at least two of the first plurality of bags.

Aspect 3. The apparatus according to any of aspects 1-2, further comprising a plurality of dividers, each divider of the plurality of dividers disposed between at least two of the second plurality of bags.

Aspect 4. The apparatus according to any of aspects 1-3, wherein the first container segment and the second container segment are each formed of metal.

Aspect 5. The apparatus according to any of aspects 1-4 wherein the compression layer includes a polymer.

Aspect 6. The apparatus according to any of aspects 1-5, wherein the compression layer includes a metal.

Aspect 7. The apparatus according to any of aspects 1-5, wherein the compression layer is formed of a padding material.

Aspect 8. The apparatus according to any of aspects 1-8, wherein the compression layer has thermal conductivity a in a range from 15 to 215 W/(mK).

Aspect 9. The apparatus according to any of aspects 1-8, wherein the compression layer is configured to directly contact bags of the first plurality of bags.

Aspect 10. The apparatus according to any of aspects 1-9, wherein the compression layer is configured to directly contact bags of a third plurality of bags, wherein the bags of the third plurality of bags each directly contact at least one bag of the first plurality of bags.

Aspect 11. The apparatus according to any of aspects 1-10, wherein the compression layer is configured to directly contact bags of the second plurality of bags.

Aspect 12. The apparatus according to any of aspects 1-11, wherein the compression layer is configured to directly contact bags of a third plurality of bags, wherein the bags of the third plurality of bags each directly contact at least one bag of the second plurality of bags.

Aspect 13. A method, comprising:
arranging a first plurality of bags in a first layer directly contacting a first container segment of a container;
placing a compression layer within the first container segment;
arranging a second plurality of bags in a second layer; and
attaching a second container segment to the first container segment to close the container, wherein:
when the second container segment is attached to the first container segment, the second plurality of bags directly contact the second container segment, the first plurality of bags is compressed against the first container segment, and the second plurality of bags is compressed against the second container segment.

Aspect 14. The method according to aspect 13, wherein the compression layer directly contacts the first plurality of bags.

Aspect 15. The method according to any of aspects 13-14, wherein the compression layer directly contacts the second plurality of bags.

Aspect 16. The method according to any of aspects 13-15 further comprising placing a third plurality of bags such that each bag of the third plurality of bags is in direct contact with at least one bag of the first plurality of bags, wherein the compression layer directly contacts the third plurality of bags.

Aspect 17. The method according to any of aspects 13-16, further comprising placing a third plurality of bags such that each bag of the third plurality of bags is in direct contact with at least one bag of the second plurality of bags, wherein the compression layer directly contacts the third plurality of bags.

Aspect 18. The method according to any of aspects 13-17, wherein the first container segment and the second container segment are each formed of metal.

Aspect 19. The method according to any of aspects 13-18, further comprising, after attaching the second container segment to the first container segment, freezing contents of bags within the container.

Aspect 20. The method according to any of aspects 13-19, further comprising, after attaching the second container segment to the first container segment, thawing contents of bags within the container.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. An apparatus comprising a container, the container including:
a first container segment configured to directly contact a first plurality of bags arranged in a first layer;
a second container segment configured to be attached to the first container segment, the second container segment configured to contact a second plurality of bags arranged in a second layer;
a compression layer, the compression layer configured to be positioned between the first plurality of bags and the second plurality of bags such that the first plurality of bags are pressed against the first container segment and the second plurality of bags are pressed against the second container segment when the first container segment is attached to the second container segment.

2. The apparatus of claim 1, further comprising a plurality of dividers, each divider of the plurality of dividers disposed between at least two of the first plurality of bags.

3. The apparatus of claim 1, further comprising a plurality of dividers, each divider of the plurality of dividers disposed between at least two of the second plurality of bags.

4. The apparatus of claim 1, wherein the first container segment and the second container segment are each formed of metal.

5. The apparatus of claim 1, wherein the compression layer includes a polymer.

6. The apparatus of claim 1, wherein the compression layer includes a metal.

7. The apparatus of claim 1, wherein the compression layer is formed of a padding material.

8. The apparatus of claim 1, wherein the compression layer has a thermal conductivity in a range from 15 to 215 W/(mK).

9. The apparatus of claim 1, wherein the compression layer is configured to directly contact bags of the first plurality of bags.

10. The apparatus of claim 1, wherein the compression layer is configured to directly contact bags of a third plurality of bags, wherein the bags of the third plurality of bags each directly contact at least one bag of the first plurality of bags.

11. The apparatus of claim 1, wherein the compression layer is configured to directly contact bags of the second plurality of bags.

12. The apparatus of claim 1, wherein the compression layer is configured to directly contact bags of a third plurality of bags, wherein the bags of the third plurality of bags each directly contact at least one bag of the second plurality of bags.

13. A method, comprising:
arranging a first plurality of bags in a first layer directly contacting a first container segment of a container;
placing a compression layer within the first container segment;
arranging a second plurality of bags in a second layer; and
attaching a second container segment to the first container segment to close the container, wherein:
when the second container segment is attached to the first container segment, the second plurality of bags directly contact the second container segment, the first plurality of bags is compressed against the first container segment, and the second plurality of bags is compressed against the second container segment.

14. The method of claim 13, wherein the compression layer directly contacts the first plurality of bags.

15. The method of claim 13, wherein the compression layer directly contacts the second plurality of bags.

16. The method of claim 13, further comprising placing a third plurality of bags such that each bag of the third plurality of bags is in direct contact with at least one bag of the first plurality of bags, wherein the compression layer directly contacts the third plurality of bags.

17. The method of claim 13, further comprising placing a third plurality of bags such that each bag of the third plurality of bags is in direct contact with at least one bag of the second plurality of bags, wherein the compression layer directly contacts the third plurality of bags.

18. The method of claim 13, wherein the first container segment and the second container segment are each formed of metal.

19. The method of claim 13, further comprising, after attaching the second container segment to the first container segment, freezing contents of bags within the container.

20. The method of claim 13, further comprising, after attaching the second container segment to the first container segment, thawing contents of bags within the container.
